(19) United States
(12) Patent Application Publication
(10) Pub. No.: US 2021/0374688 A1
(43) Pub. Date: Dec. 2, 2021

(54) SYSTEM AND METHOD FOR DYNAMICALLY AND OPTIMALLY POSITIONING SMART BINS IN A GEOGRAPHICAL AREA

(71) Applicant: HCL Technologies Italy S.p.A., Vimodrone (Milano) (IT)

(72) Inventors: Massimo Marra, Rome (IT); Nicola Milanese, Rome (IT)

(73) Assignee: HCL Technologies Italy S.p.A.

(21) Appl. No.: 16/890,197

(22) Filed: Jun. 2, 2020

(51) Int. Cl. G06Q 10/00; G06K 9/00

(52) U.S. Cl. CPC G06Q 10/30; G06K 9/00765

(57) ABSTRACT

System and method for determining an optimal position of smart bins is disclosed. In some embodiments, the method may include, for each of a set of regions of interest within a geographical area and for each of a set of pre-defined timeslots of a day, determining a set of evaluation parameters for a region of interest based on an evaluation of video feeds for the region of interest, and generating a probability map for the region of interest based on the set of evaluation parameters. The method may further include determining the optimal position of each of a plurality of smart bins within the geographical area based on the probability map for each of the set of regions of interest and for each of the set of pre-defined timeslots of the day.

### FIELD OF INVENTION

This disclosure relates generally to smart bins, and more particularly to a system and a method for dynamically and optimally positioning smart bins in a geographical area.

### BACKGROUND OF INVENTION

Effective and timely removal of trash is an important factor in maintaining cleanliness and hygiene of geographical areas, especially public places like offices, airports, hospitals, etc. As it will be appreciated, availability and proximity of trash bins to users in the geographical area play an important role in effective and timely disposal of trash. To this end, a large number of trash bins may be deployed in the geographical area under the assumption that larger number of trash bins will lead to a greater level of cleanliness in the geographical area.

It may happen that a person within the geographical area may need to dispose something (trash) in the trash bin. However, if the trash bin is positioned far away from the user, or if the trash bin is already full, the user may be discouraged to put the trash in the trash bin, and may end up littering the trash in the open, thereby hampering the cleanliness level of the geographical area. In other words, unintelligent and/or static positioning of trash bins with the geographical areas fail to provide an effective solution for maintaining cleanliness and hygiene of geographical areas.

### SUMMARY OF INVENTION

In one embodiment, a method for determining an optimal position of each of a plurality of smart bins is disclosed. For each of a set of regions of interest within a geographical area and for each of a set of pre-defined timeslots of a day, the method may include determining a set of evaluation parameters for a region of interest based on an evaluation of video feeds for the region of interest, and generating a probability map for the region of interest based on the set of evaluation parameters. The probability map may correspond to a need of one or more of the plurality of smart bins at one or more different positions within the region of interest. The method may further include determining the optimal position of each of the plurality of smart bins within the geographical area based on the probability map for each of the set of regions of interest and for each of the set of pre-defined timeslots of the day.

In another embodiment, a system for determining an optimal position of each of a plurality of smart bins is disclosed. The system may include a processor and a memory communicatively coupled to the processor. The memory stores processor-executable instructions, which, on execution, may cause the processor to perform various operations. For each of a set of regions of interest within a geographical area and for each of a set of pre-defined timeslots of a day, the operations may include determining a set of evaluation parameters for a region of interest based on an evaluation of video feeds for the region of interest, and generating a probability map for the region of interest based on the set of evaluation parameters. The probability map may correspond to a need of one or more of the plurality of smart bins at one or more different positions within the region of interest. The operations may further include determining the optimal position of each of the plurality of smart bins within the geographical area based on the probability map for each of the set of regions of interest and for each of the set of pre-defined timeslots of the day.

In yet another embodiment, a non-transitory computer-readable storage medium is disclosed. The non-transitory computer-readable storage medium has stored thereon, a set of computer-executable instructions causing a computer comprising one or more processors to perform steps. For each of a set of regions of interest within a geographical area and for each of a set of pre-defined timeslots of a day, the steps may include determining a set of evaluation parameters for a region of interest based on an evaluation of video feeds for the region of interest, and generating a probability map for the region of interest based on the set of evaluation parameters. The probability map may correspond to a need of one or more of the plurality of smart bins at one or more different positions within the region of interest. The steps may further include determining the optimal position of each of the plurality of smart bins within the geographical area based on the probability map for each of the set of regions of interest and for each of the set of pre-defined timeslots of the day.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of a computing system that may be employed to implement processing functionality for various embodiments.

FIG. 2 is a functional block diagram of an exemplary system for determining an optimal position of smart bins, in accordance with some embodiments of the present disclosure.

FIG. 3 illustrates an exemplary process for generating a positioning probability map for a geographical area, in accordance with some embodiments of the present disclosure.

FIG. 4 is a functional block diagram of an exemplary smart bin, in accordance with some embodiments of the present disclosure.

FIG. 5 is a flowchart of an exemplary process for determining an optimal position of smart bins, in accordance with some embodiments of the present disclosure.

FIG. 6 is a flowchart of an exemplary process for effecting real-time movement of a smart bin to collect trash, in accordance with some embodiments of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

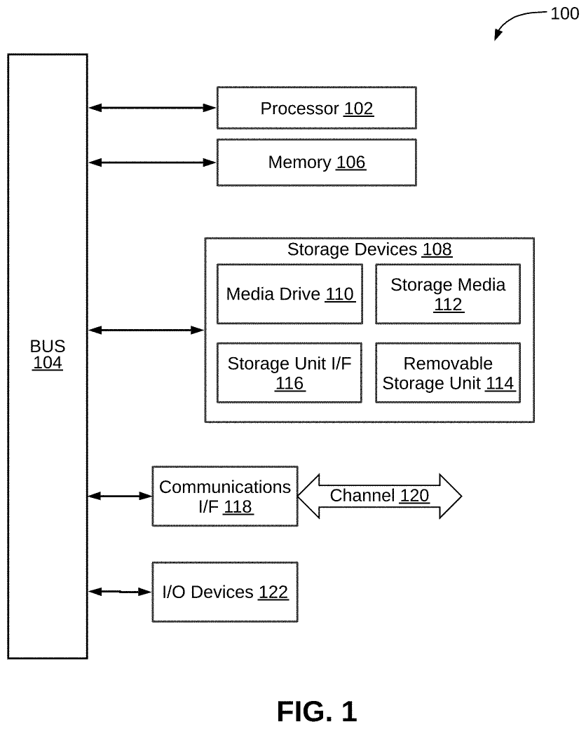

Referring now to FIG. 1, an exemplary computing system 100 that may be employed to implement processing functionality for various embodiments is illustrated. For example, the computing system 100 may be implemented as a master smart bin control device (implemented in one or more of the smart bins or on a central static bin, or taking form of a remote server, etc.). Similarly, the computing system 100 may be implemented as a local smart bin control device (implemented in each of the smart bins). Thus, the computing system 100 may, for example, take form of a server, a desktop, a laptop, a process-based smart bin, or any other type of special or general-purpose computing device as may be desirable or appropriate for a given application or environment. The master smart bin control device may be communicatively coupled to the local smart bin control devices. For example, the master smart bin control device may be in wireless communication with the local smart bin control devices. Those skilled in the relevant art will also recognize how to implement the invention using other computer systems or architectures.

The computing system 100 may include one or more processors, such as a processor 102 that may be implemented using a general or special purpose processing engine such as, for example, a microprocessor, microcontroller or other control logic. In this example, the processor 102 is connected to a bus 104 or other communication medium. The computing system 100 may also include a memory 106 (main memory), for example, Random Access Memory (RAM) or other dynamic memory, for storing information and instructions to be executed by the processor 102. The memory 106 also may be used for storing temporary variables or other intermediate information during execution of instructions to be executed by the processor 102. The computing system 100 may likewise include a read only memory (“ROM”) or other static storage device coupled to bus 104 for storing static information and instructions for the processor 102.

The computing system 100 may also include a storage device 108, which may include, for example, a media drive 110 and a removable storage interface. The media drive 110 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 112 may include, for example, a hard disk, magnetic tape, flash drive, or other fixed or removable medium that is read by and written to by the media drive 110. As these examples illustrate, the storage media 112 may include a computer-readable storage medium having stored therein particular computer software or data.

In alternative embodiments, the storage devices 108 may include other similar instrumentalities for allowing computer programs or other instructions or data to be loaded into the computing system 100. Such instrumentalities may include, for example, a removable storage unit 114 and a storage unit interface 116, such as a program cartridge and cartridge interface, a removable memory (for example, a flash memory or other removable memory) and memory slot, and other removable storage units and interfaces that allow software and data to be transferred from the removable storage unit 114 to the computing system 100.

The computing system 100 may also include a communications interface 118. The communications interface 118 may be used to allow software and data to be transferred between the computing system 100 and external devices or system. Examples of the communications interface 118 may include a network interface (such as an Ethernet or other NIC card), a communications port (such as for example, a USB port, a micro USB port), Near field Communication (NFC), etc. Software and data transferred via the communications interface 118 are in the form of signals which may be electronic, electromagnetic, optical, or other signals capable of being received by the communications interface 118. These signals are provided to the communications interface 118 via a channel 120. The channel 120 may carry signals and may be implemented using a wireless medium, wire or cable, fiber optics, or another communication medium. Some examples of the channel 120 may include a phone line, a cellular phone link, an RF link, a Bluetooth link, a network interface, a local or wide area network, and other communications channels.

The computing system 100 may further include Input/Output (I/O) devices 122. Examples may include, but are not limited to a display, keypad, microphone, audio speakers, vibrating motor, LED lights, etc. The I/O devices 122 may receive input from a user and also display an output of the computation performed by the processor 102. In this document, the terms “computer program product” and “computer-readable medium” may be used generally to refer to media such as, for example, the memory 106, the storage devices 108, the removable storage unit 114, or signal(s) on the channel 120. These and other forms of computer-readable media may be involved in providing one or more sequences of one or more instructions to the processor 102 for execution. Such instructions, generally referred to as “computer program code” (which may be grouped in the form of computer programs or other groupings), when executed, enable the computing system 100 to perform features or functions of embodiments of the present invention.

In some embodiments where the elements are implemented using software, the software may be stored in a computer-readable medium and loaded into the computing system 100 using, for example, the removable storage unit 114, the media drive 110 or the communications interface 118. The control logic (in this example, software instructions or computer program code), when executed by the processor 102, causes the processor 102 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

The present disclosure relates to determining an optimal position of smart bins with a geographical area. To this end, a system is disclosed that may include a master smart bin control device (implemented in a central static bin or on one or more of the smart bins, or taking form of a remote server device, etc.) and a number of smart bins (that implements local smart bin control device). In some embodiments, the master smart bin may be the central static bin fixed at one position, while the smart bins may be capable of moving within the geographical area. Further, each of smart bin may include a camera that may allow it to obtain a video of at least a region within the geographical area. For example, using the video, a position where a person carrying trash or likely to be carrying trash may be identified, and the smart bin may be caused to move to that position to collect the trash from the person. In such embodiments, the master smart bin may act as a central trash repository, where a smart bin may dispose the collected trash once the smart bin is full. Further, the master smart bin and each of the smart bins may have processing capability. The master smart bin may communicate with each of the smart bins and determine an optimal positioning and movement path for each smart bin.

For example, the master bin may generate positioning probability map for the geographical area and determine optimal position of each of the smart bins within the geographical area based on the positioning probability map. The master bin may then trigger movement of the smart bins to their respective optimal positions. Now, when a group of persons stops (e.g. for talking) at one position in the geographical region and some of the persons in the group are smoking (e.g., anticipated trash), the closest smart bin may start moving towards this group of persons. This smart bin may further notify the master smart bin and the rest of the smart bins about the same. Upon receiving the notification, the master smart bin may communicate it to all the remaining smart bins. By way of this, an unnecessary movement of the remaining smart bins towards the group of persons is avoided (since, one of the smart bins has already moved to that position). Further, once a smart bin is full (or almost full) with trash, that smart bin may automatically move to the master smart bin to empty the trash. The master smart bin may dynamically compute a new optimal position for each of the remaining smart bins and effect movement of each of the remaining smart bins based on the respective new optimal position.

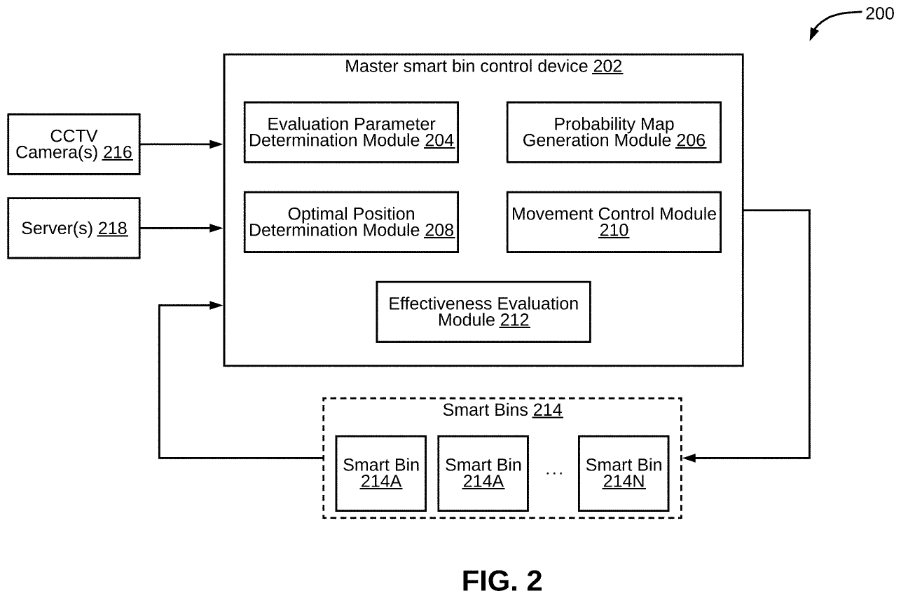

Referring now to FIG. 2, a functional block diagram of an exemplary system 200 for determining an optimal position of each of the smart bins 214 is illustrated, in accordance with some embodiments of the present disclosure. The system 200 may include a master smart bin control device 202 communicatively coupled to a number of smart bins 214A . . . 214N (collectively represented by reference numeral 214, one or more CCTV cameras 216, and one or more servers 218. By way of an example, in some embodiments, the master smart bin control device 202 may be implemented in a central static bin (not shown in FIG. 2). Alternatively, in some embodiments, the master smart bin control device 202 may be implemented in one or more of the smart bins 214. For example, the public place in which the system 200 is deployed may include one or more master smart bins in communication with each other and each master bin may control a set of smart bins. Alternatively, in some embodiments, the master smart bin control device 202 may be take the form of a remote server. As will be appreciated, in such embodiments, the master bin control device may just perform control and management of the smart bins 214.

The master smart bin control device 202 may be communicatively coupled to each of the smart bins 214, the one or more CCTV cameras 216, and the one or more servers 218, via a communication channel. By way of an example, the system 200 may be deployed in a geographical area, for example, a public place for cleaning purposes. Examples of public places may include squares, streets, offices, airports, hospitals, etc. It may be noted that each of the smart bins 214 may include an imaging device (e.g., camera) to capture video feeds of the surround environment and transmit the same to the master smart bin control device 202. Further, in some embodiments, the master smart bin control device 202 may receive video feeds from the one or more CCTV cameras 216 installed on infrastructures within the geographical area. Furthermore, in some embodiments, the master smart bin control device 202 may receive historic or real-time video feeds of the geographical area stored on one or more servers 218 (e.g., third-party sever such as server storing video feeds acquired by public/private CCTV surveillance cameras, server storing video feeds acquired by smart bins, and so forth). In other words, the one or more servers 218 may store video feeds obtained in the past, or video feeds obtained in real-time by the smart bins 214 (through their corresponding image capturing devices), or by the public/private CCTV cameras 216.

In some embodiments, the master smart bin control device 202 may include evaluation parameter determination module 204, a probability map generation module 206, an optimal position determination module 208, a movement control module 210, and an effectiveness evaluation module 212. Each of these modules 204-212 will be described in greater detail herein below.

The evaluation parameter determination module 204 may receive video feeds from at least one of the smart bins 214, the one or more CCTV cameras 216, or the one or more servers 218. It may be noted that the video feeds may be obtained for the entire geographical area or for a portion of the geographic area. The evaluation parameter determination module 204 may further determine a set of regions of interest within the geographical area based on the video feeds. The evaluation parameter determination module 204 may further evaluate video feeds for a region of interest (from the set of regions of interest) to determine a set of evaluation parameters for that region of interest. In some embodiments, the set of evaluation parameters may include at least one of a presence of one or more persons within the region of interest, a position of each of the one or more persons within the region of interest, an action of each of the one or more persons, and objects associated with each of the one or more persons. In some embodiments, the evaluation parameter determination module 204 may correlate these evaluation parameters to determine additional evaluation parameters. The additional evaluation parameters may include, but may not be limited to, a single person standing/walking while smoking and/or drinking beverage, a group of persons walking/standing while smoking and/or drinking beverage, a person eating something while rushing to office, and a person talking on phone while pacing.

It may be understood that the set of regions of interest may include various sub-areas of the geographical area (e.g., a seating area, a coffee shop, a boarding gate, etc. of an airport). In some embodiments, the evaluation parameter determination module 204 may evaluate video feeds for the region of interest for each of a set of pre-defined timeslots of a day. The set of pre-defined timeslots of a day may be defined based on one or more pre-defined criteria. For example, the one or more pre-defined criteria may include an hourly distribution (e.g., 2 PM-3 PM timeslot, 3 PM-4 PM timeslot, etc.). In some embodiments, these criteria may be defined based on existing or acquired knowledge of different regions of interest within the geographical area. For example, the one or more criteria may include engagement hour distribution associated with the region of interest (office starting hours, office hours, office break hours, office closing hours, shopping hours, non-shopping hours, weekend rush hours, etc.). Thus, the evaluation parameter determination module 204 may analyze video feeds for each region of interest (from the set of regions of interest) and for each pre-defined timeslot of the day (of the set of pre-defined timeslots of the day).

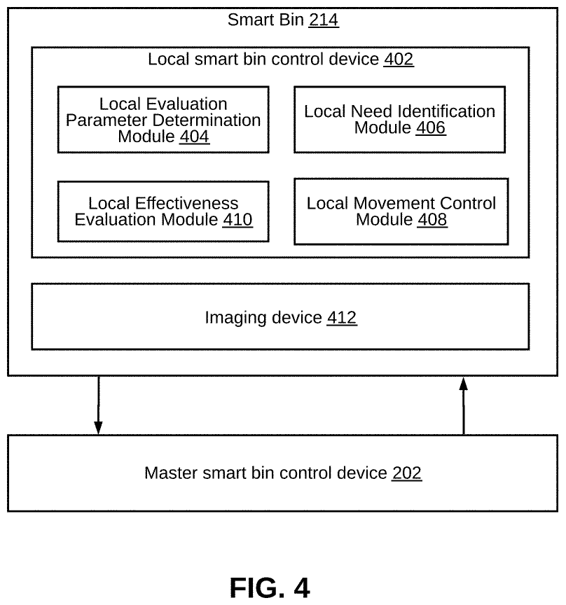

In some embodiments, the probability map generation module 206 may receive the set of evaluation parameters from the evaluation parameter determination module 204. The probability map generation module 206 may determine a need of one or more of the smart bins 214 at one or more different positions within the region of interest, based on the set of evaluation parameters. It may be noted that the need of one or more of the smart bins 214 at one or more different positions within the region of interest may be determined for each of the set of regions of interest within the geographical area and for each of the set of pre-defined timeslots of the day. The probability map generation module 206 may further generate a probability map for the region of interest based on the set of evaluation parameters. It may be noted that the probability map may correspond to a need of one or more of the smart bins 214 at one or more different positions within the region of interest. It may be further noted that a probability map may be generated for each of the set of regions of interest within the geographical area, and for each of the set of pre-defined timeslots of the day. By way of an example, the probability map may be a heat map which may reflect a need of the one or more of the smart bins 214 at different positions within the region of interest. As will be described in greater detail in conjunction with FIG. 4, in some embodiments, the probability map for the region of interest may be generated by each of the smart bins 214. To this end, each of the smart bins 214 may have a processing capability for probability map generation.

It may be noted that a smart bin may be caused to move only if there exists a reasonable probability of a need to do so. It may be understood that a preferred state of the smart bin may be static state, i.e., when the smart bin is not moving. A needless movement of the smart bin may be undesirable. Therefore, in order to avoid any needless movement of the smart bins 214, a probability of a need of movement of the smart bin may be generated (for example, based on object recognition using the onboarded camera). A probability map may be then generated based on probabilities of the need at different position within the region of interest. By way of an example, the probability map may be based on people detected, objects (e.g. food, beverages, mobile phones, etc.) associated with the detected people, and velocity of a person. It may be noted that the velocity can be determined by interpolating subsequent frames.

In an example scenario, a group of persons may be walking while eating something (an object). A probability associated with a moving person may be combined with a probability associated with the object. For example, for a moving person not eating while walking, the probability of having a need to dispose trash will be lower as compared to a person eating something. Similarly, for a person with a mobile phone in hand, the probability of having a need to dispose trash will be low.

The optimal position determination module 208 may receive the probability map from the probability generation module 206. The optimal position determination module 208 may further determine an optimal position of each of the smart bins 214 within the geographical area based on the probability map for each of the set of regions of interest and for each of the set of pre-defined timeslots of the day. For example, in a geographical area corresponding to an airport, the optimal position determination module 208 may determine an optimal position of each of the smart bins 214 at each sub-area (e.g. seating area, a coffee shop, a boarding gate, etc.) at different timeslots of the day (e.g. 2 PM-3 PM, 3 PM-4 PM, etc.)

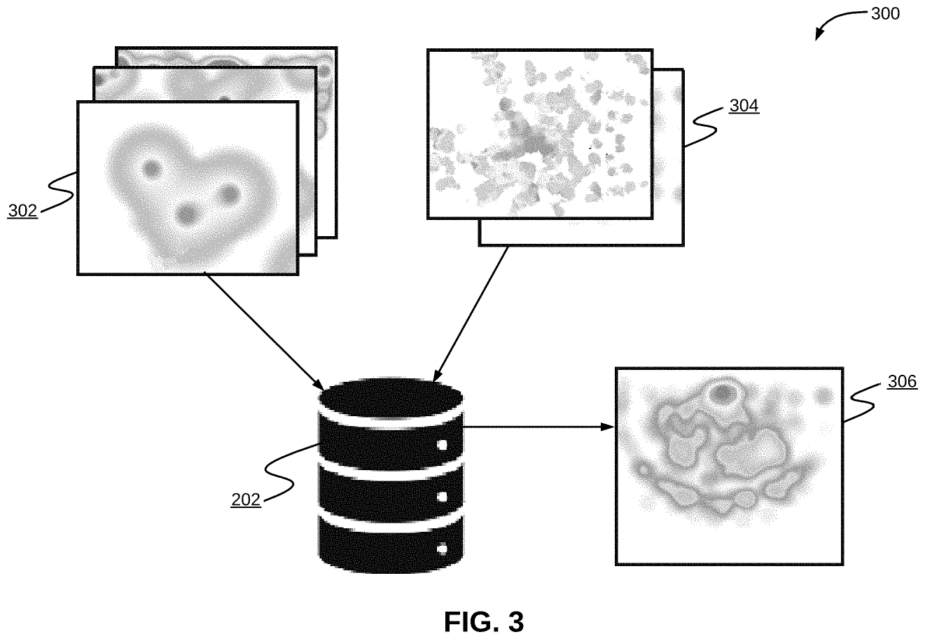

In some embodiments, the probability map generation module 206 may further generate a positioning probability map for the geographical area for a pre-defined timeslot of the day by aggregating the probability map for each of the set of regions of interest for a pre-defined timeslot of the set of pre-defined timeslots of the day. It may be noted that the positioning probability map may be generated for each of the set of pre-defined timeslots of the day. In other words, the probability maps for all the regions of interest for a given pre-defined timeslot may be aggregated to generate the positioning probability map for that pre-defined timeslot. Similarly, positioning probability maps for the remaining pre-defined timeslots may be generated. It may be further understood that a positioning probability map for a pre-defined timeslot may indicate the need of one or more of the smart bins 214 at one or more different positions within the entire geographical area at that pre-defined timeslot. This is further explained in conjunction with FIG. 3.

Referring now to FIG. 3, an exemplary process 300 for generating a positioning probability map for a geographical area is illustrated, in accordance with some embodiments of the present disclosure. The master smart bin control device 202 may receive probability maps 302 for the set of regions of interest for a first pre-defined timeslot T1 (of the set of pre-defined timeslots) of the day. In other words, master smart bin control device 202 may receive the probability maps 302 for all the regions of interest for the first pre-defined timeslot T1. The master smart bin control device 202 may generate first a positioning probability map (not shown in FIG. 3) for the geographical area for the first pre-defined timeslot T1 by aggregating the probability maps 302 for the set of regions of interest for the first pre-defined timeslot T1.

The master smart bin control device 202 may further receive probability maps 304 for the set of regions of interest for a second pre-defined timeslot T2 of the set of pre-defined timeslots of the day. The master smart bin control device 202 may then generate a second positioning probability map (not shown in FIG. 3) for the geographical area for the second pre-defined timeslot T2 by aggregating the probability maps 304 for the set of regions of interest for the pre-defined timeslot T2. In some embodiments, the master smart bin control device 202 may aggregate the positioning probability maps for the geographical area for the set of pre-defined timeslots (i.e. of T1, T2, . . . and so on) to generate a time-aggregated positioning probability map 306.

Referring back to FIG. 2, in some embodiments, the optimal position determination module 208 may further determine the optimal position of each of the smart bins 214 within the geographical area for the pre-defined timeslot based on the positioning probability map for the geographical area for the pre-defined timeslot. It may be understood that the optimal position determination module 208 may determine the optimal position of each of the smart bins 214 within the geographical area for each of the set of pre-defined timeslots of the day.

In some embodiments, the movement control module 210 may determine a movement policy for each of the smart bins 214 in the pre-defined timeslot based on at least one of the positioning probability map for the pre-defined timeslot, a current position of each of the smart bins 214, and a current status of each of the smart bins 214. By way of an example, the current position of a smart bin may correspond to the position of the smart bin within the geographical area, before the smart bin has started to perform movement according to the movement policy that smart bin. Further a current status of a smart bin may correspond to a degree to which that smart bin is full (with trash).

It may be noted that the movement policy for a smart bin may include a comprehensive set of coordinated moving commands that the smart bin may follow. For example, the movement policy may define position coordinates which the smart bin may traverse along while performing movement. It may be further understood that the movement policy may be defined in order to provide the best possible path for the movement of the smart bin, in terms of distance covered or time taken. Further, the movement policy may take into consideration the current status of the smart bin. In some embodiments, the movement control module 210 may further effect positioning of each of the smart bins 214 within the geographical area based on the respective movement policy.

In some embodiments, the effectiveness evaluation module 212 may evaluate an effectiveness of the movement of the smart bin based on an occurrence of actual trashing of a trash in the smart bin. For example, once a movement of the smart bin is successful (i.e. something is actually trashed into the bin), the effectiveness evaluation module 212 may receive an acknowledgement for the same. Based on the acknowledgement, the effectiveness evaluation module 212 may determine an effectiveness or non-effectiveness of the movement of the associated smart bin. In some embodiments, the evaluated effectiveness may act as training data for future movements of the smart bins. Thus, the probability generation module 206 may update a decision-making logic for determining the need based on the feedback (with respect to the effectiveness) received from the effectiveness evaluation module 212. Further, based on the updated decision-making logic, the optimal position determination module 208 may update the optimal position of each of the smart bins 214 within the geographical area.

In some embodiments, the optimal position of each of the smart bins 214 may be determined based on a real-time video feed of the region of interest. Further, in some embodiments, the optimal position of each of the smart bins 214 may be determined by the master bin control device 202. To this end, the evaluation parameter determination module 204 may receive a real-time video feed of the region of interest. Accordingly, the probability map generation module 206 may determine a need of the smart bin at a position of interest or for a person of interest, within the region of interest, based on an evaluation of the real-time video feed. Further, once the need of the smart bin at the position of interest or for the person of interest within the region of interest is determined, the movement control module 210 may effect a movement of the smart bin to the position of interest or to the person of interest.

In alternate embodiments, the optimal position of each of the smart bins 214 may be determined based on real-time video feed of the region of interest, by a local smart bin control device within each of the smart bins 214 positioned in the region of interest. To this end, at least one of the smart bins 214 may include the local smart bin control device. However, it may be understood that the each of the smart bins 214 may implement a local smart bin control device. This is further explained in detail, in conjunction with FIG. 4.

Referring now to FIG. 4, a functional block diagram of an exemplary smart bin 214 is illustrated, in accordance with some embodiments of the present disclosure. As stated above, the smart bin 214 may be in communication with the master smart bin control device 202. The smart bin 214 may include an exemplary local smart bin control device 402 and an imaging device 414. In some embodiments, the local smart bin control device 402 may include a local evaluation parameter determination module 404, a local need identification module 406, a local movement control module 408, and a local effectiveness evaluation module 410. Each of these modules 404-410 will be described in greater detail herein below.

The local evaluation parameter determination module 404 may receive a real-time video feed of the region of interest. By way of an example, the local evaluation parameter determination module 404 may receive the real-time video feed from the imaging device 412. The local evaluation parameter determination module 404 may then evaluate video feeds to determine a set of evaluation parameters. In some embodiments, the evaluation may be performed in a manner similar to that explained with respect to the evaluation parameter determination module 204. The local need identification module 406 may determine a need of the smart bin 214 at a position of interest or for a person of interest based on the evaluation of the evaluation parameters. Additionally, in some embodiments, the local need identification module 406 may generate a probability map for a local region based on the need of the smart bin 214 at one or more different positions within the local region. In some embodiments, the need identification and probability map generation may be performed in a manner similar to that explained with respect to the probability map generation module 206.

Once the need of the smart bin at a position of interest or for a person of interest is determined, the local movement control module 408 may effect a movement of the smart bin 214 to the position of interest or to the person of interest. The local effectiveness evaluation module 410 may then evaluate an effectiveness of the movement of the smart bin 214 based on an occurrence of actual trashing of a trash in the smart bin 214. In some embodiments, the effecting of the movement and determination of the effectiveness may be performed in a manner similar to that explained with respect to the movement control module 210 and the effectiveness evaluation module 212, respectively. Further, in some embodiments, the local need identification module 406 may update a decision-making logic for determining the need based on the feedback (with respect to the effectiveness) received from the local effectiveness evaluation module 410.

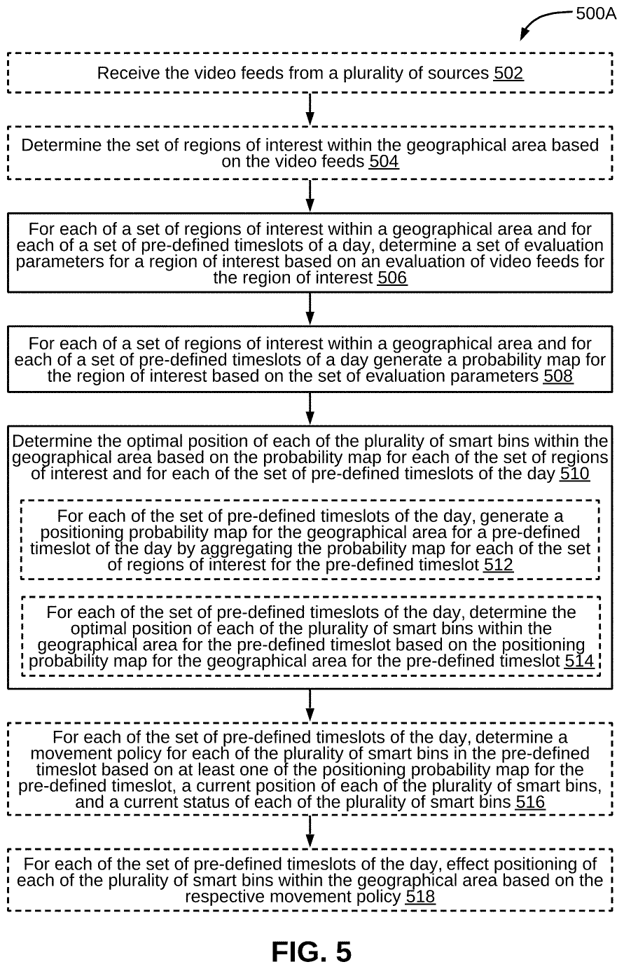

Referring now to FIG. 5, an exemplary process 500 for determining an optimal position of smart bins is illustrated, in accordance with some embodiments of the present disclosure. The process 500 may be mostly performed by the master smart bin control device 202. Each of the steps of the process 500 may be described in greater detail herein below.

In some embodiments, at step 502, the master smart bin control device 202 may receive video feeds from a plurality of sources. The plurality of sources may include at least one of cameras installed on a plurality of smart bins 214 disposed in the geographical area, CCTV cameras 216 installed on infrastructures within the geographical area, and servers 218 with historic or real-time video feeds of the geographical area. At step 504, the master smart bin control device 202 may determine a set of regions of interest within the geographical area based on the video feeds.

At step 506, for each of a set of regions of interest within the geographical area and for each of a set of pre-defined timeslots of a day, the master smart bin control device 202 may determine a set of evaluation parameters for a region of interest based on an evaluation of video feeds for the region of interest. At step 508, for each of the set of regions of interest within the geographical area and for each of the set of pre-defined timeslots of the day, the master smart bin control device 202 may generate a probability map for the region of interest based on the set of evaluation parameters. The probability map may correspond to a need of one or more of the smart bins at one or more different positions within the region of interest. The set of evaluation parameters may include at least one of a presence of one or more persons within the region of interest, a position of each of the one or more persons within the region of interest, an action of each of the one or more persons, and objects associated with each of the one or more persons.

At step 510, the master smart bin control device 202 may determine the optimal position of each of the plurality of smart bins within the geographical area based on the probability map for each of the set of regions of interest and for each of the set of pre-defined timeslots of the day. In some embodiments, the step 510 of determining the optimal position of each of the plurality of smart bins within the geographical area may further include steps 512 and 514. At step 512, for each of the set of pre-defined timeslots of the day, the master smart bin control device 202 may generate a positioning probability map for the geographical area for a pre-defined timeslot of the day by aggregating the probability map for each of the set of regions of interest for the pre-defined timeslot. At step 514, for each of the set of pre-defined timeslots of the day, the master smart bin control device 202 may determine the optimal position of each of the plurality of smart bins within the geographical area for the pre-defined timeslot based on the positioning probability map for the geographical area for the pre-defined timeslot.

In such embodiments, at step 516, for each of the set of pre-defined timeslots of the day, the master smart bin control device 202 may determine a movement policy for each of the plurality of smart bins in the pre-defined timeslot based on at least one of the positioning probability map for the pre-defined timeslot, a current position of each of the plurality of smart bins, and a current status of each of the plurality of smart bins. At step 518, for each of the set of pre-defined timeslots of the day, the master smart bin control device 202 may effect positioning of each of the plurality of smart bins within the geographical area based on the respective movement policy.

In some embodiments, the step 510 of determining the optimal position of each of the plurality of smart bins within the geographical area may further include the step of generating an aggregated positioning probability map for the geographical area by aggregating the positioning probability map for each of the set of pre-defined timeslots of the day, and the step of determining the optimal position of each of the plurality of smart bins within the geographical area based on the aggregated positioning probability map for the geographical area. In such embodiments, the process 500 may include the step determining a movement policy for each of the plurality of smart bins based on at least one of the aggregated positioning probability map for the pre-defined timeslot, a current position of each of the plurality of smart bins, and a current status of each of the plurality of smart bins, and the step of effecting positioning of each of the plurality of smart bins within the geographical area based on the respective movement policy.

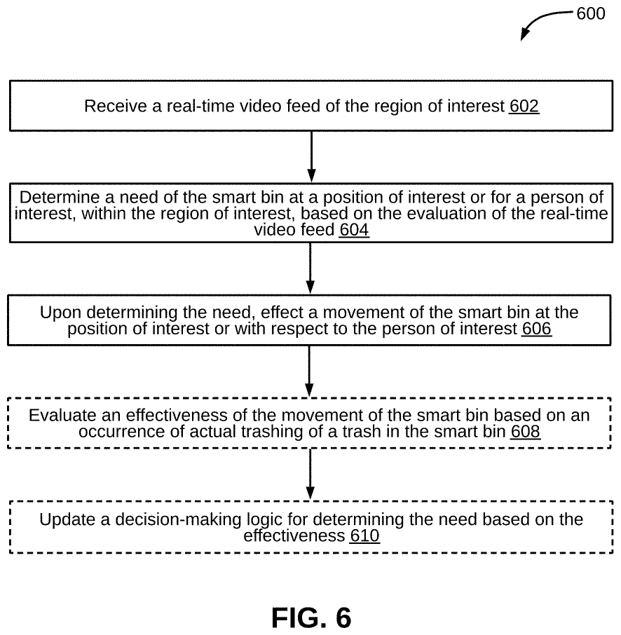

Referring now to FIG. 6, an exemplary process 600 for effecting real-time movement of a smart bin 214 to collect trash is illustrated, in accordance with some embodiments of the present disclosure. In some embodiments, the process 600 may be performed by the master smart bin control device 202 of the master smart bin. Further, in some embodiments, some or all steps of the process 600 may be performed by the local smart bin control device 402 of the smart bin.

At step 602, at least one of the master smart bin control device 202 or a local smart bin control device 402 within a smart bin 214 positioned in the region of interest may receive a real-time video feed of the region of interest. At step 604, the at least one of the master smart bin control device 202 or the local smart bin control device 402 may determine a need of the smart bin at a position of interest or for a person of interest, within the region of interest, based on an evaluation of the real-time video feed. At step 606, upon determining the need, the at least one of the master smart bin control device 202 or the local smart bin control device 402 may effect a movement of the smart bin to the position of interest or to the person of interest. In some embodiments, the method 600 may further include steps 608 and 610. At step 608, the at least one of the master smart bin control device 202 or the local smart bin control device 402 may evaluate an effectiveness of the movement of the smart bin based on an occurrence of actual trashing of a trash in the smart bin. At step 612, the at least one of the master smart bin control device 202 or the local smart bin control device 402 may update a decision-making logic for determining the need based on the effectiveness.

As will be appreciated by those skilled in the art, the above techniques relate to determining an optimal position of each of a plurality of smart bins within a geographical area. The techniques may be used for cleaning of the geographical area, for example, public places like squares, streets, offices, airports, hospitals, etc., using the plurality of self-moving smart bins. The techniques provide for an optimal position of each of a plurality of smart bins within the geographical area, for effective and timely removal/collection of trash from the geographical area. By way of determining the optimal position of each of the plurality of smart bins, the techniques ensure that the smart bins are readily available, especially at regions within the geographical area where the likelihood of trash generation is higher. Further the techniques ensure that the smart bins are readily available during timeslots of the day during which the likelihood of trash generation is higher.

As will be appreciated by those skilled in the art, the techniques described in various embodiments discussed above is not only limited to positioning and movement of smart bins for trash collection, but also applicable (with no or minor modification) to positioning and movement of any assistance robots for a wide variety of applications (e.g., assisting delegates in a large conference). In particular, the specification has described method and system for determining an optimal position of smart bins. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of determining an optimal position of each of a plurality of smart bins, the method comprising:
for each of a set of regions of interest within a geographical area and for each of a set of pre-defined timeslots of a day,
determining, by a master smart bin control device, a set of evaluation parameters for a region of interest based on an evaluation of video feeds for the region of interest; and
generating, by the master smart bin control device, a probability map for the region of interest based on the set of evaluation parameters, wherein the probability map corresponds to a need of one or more of the plurality of smart bins at one or more different positions within the region of interest; and
determining, by the master smart bin control device, the optimal position of each of the plurality of smart bins within the geographical area based on the probability map for each of the set of regions of interest and for each of the set of pre-defined timeslots of the day.

2. The method of claim 1, further comprising:
receiving, by the master smart bin control device, the video feeds from a plurality of sources, wherein the plurality of sources comprises at least one of cameras installed on the plurality of smart bins disposed in the geographical area, CCTV cameras installed on infrastructures within the geographical area, and servers with historic or real-time video feeds of the geographical area; and
determining, by the master smart bin control device, the set of regions of interest within the geographical area based on the video feeds.

3. The method of claim 1, wherein the set of evaluation parameters comprises at least one of a presence of one or more persons within the region of interest, a position of each of the one or more persons within the region of interest, an action of each of the one or more persons, and objects associated with each of the one or more persons.

4. The method of claim 1, wherein determining the optimal position of each of the plurality of smart bins within the geographical area comprises:
for each of the set of pre-defined timeslots of the day,
generating, by the master smart bin control device, a positioning probability map for the geographical area for a pre-defined timeslot of the day by aggregating the probability map for each of the set of regions of interest for the pre-defined timeslot; and
determining, by the master smart bin control device, the optimal position of each of the plurality of smart bins within the geographical area for the pre-defined timeslot based on the positioning probability map for the geographical area for the pre-defined timeslot.

5. The method of claim 4, further comprising:
for each of the set of pre-defined timeslots of the day,
determining, by the master smart bin control device, a movement policy for each of the plurality of smart bins in the pre-defined timeslot based on at least one of the positioning probability map for the pre-defined timeslot, a current position of each of the plurality of smart bins, and a current status of each of the plurality of smart bins; and
effecting, by the master smart bin control device, positioning of each of the plurality of smart bins within the geographical area based on the respective movement policy.

6. The method of claim 4, wherein determining the optimal position of each of the plurality of smart bins within the geographical area comprises:
generating, by the master smart bin control device, an aggregated positioning probability map for the geographical area by aggregating the positioning probability map for each of the set of pre-defined timeslots of the day; and
determining, by the master smart bin control device, the optimal position of each of the plurality of smart bins within the geographical area based on the aggregated positioning probability map for the geographical area.

7. The method of claim 6, further comprising:
determining, by the master smart bin control device, a movement policy for each of the plurality of smart bins based on at least one of the aggregated positioning probability map for the pre-defined timeslot, a current position of each of the plurality of smart bins, and a current status of each of the plurality of smart bins; and
effecting, by the master smart bin control device, positioning of each of the plurality of smart bins within the geographical area based on the respective movement policy.

8. The method of claim 1, further comprising:
receiving, by at least one of the master smart bin control device or a local smart bin control device within a smart bin positioned in the region of interest, a real-time video feed of the region of interest;
determining, by the at least one of the master smart bin control device or the local smart bin control device, a need of the smart bin at a position of interest or for a person of interest, within the region of interest, based on an evaluation of the real-time video feed; and
upon determining the need, effecting, by the at least one of the master smart bin control device or the local smart bin control device, a movement of the smart bin to the position of interest or to the person of interest.

9. The method of claim 8, further comprising:
evaluating, by the at least one of the master smart bin control device or the local smart bin control device, an effectiveness of the movement of the smart bin based on an occurrence of actual trashing of a trash in the smart bin; and
updating, by the at least one of the master smart bin control device or the local smart bin control device, a decision-making logic for determining the need based on the effectiveness.

10. A system for determining an optimal position of each of a plurality of smart bins, the system comprising:
a processor; and
a memory communicatively coupled to the processor, wherein the memory stores processor-executable instructions, which, on execution, causes the processor to:
for each of a set of regions of interest within a geographical area and for each of a set of pre-defined timeslots of a day,
determine a set of evaluation parameters for a region of interest based on an evaluation of video feeds for the region of interest; and
generate a probability map for the region of interest based on the set of evaluation parameters, wherein the probability map corresponds to a need of one or more of the plurality of smart bins at one or more different positions within the region of interest; and
determine the optimal position of each of the plurality of smart bins within the geographical area based on the probability map for each of the set of regions of interest and for each of the set of pre-defined timeslots of the day.

11. The system of claim 10, wherein the processor-executable instructions, on execution, further cause the processor to:
receive the video feeds from a plurality of sources, wherein the plurality of sources comprises at least one of cameras installed on the plurality of smart bins disposed in the geographical area, CCTV cameras installed on infrastructures within the geographical area, and servers with historic or real-time video feeds of the geographical area; and
determine the set of regions of interest within the geographical area based on the video feeds.

12. The system of claim 10, wherein the set of evaluation parameters comprises at least one of a presence of one or more persons within the region of interest, a position of each of the one or more persons within the region of interest, an action of each of the one or more persons, and objects associated with each of the one or more persons.

13. The system of claim 10, wherein determining the optimal position of each of the plurality of smart bins within the geographical area comprises:
for each of the set of pre-defined timeslots of the day,
generating a positioning probability map for the geographical area for a pre-defined timeslot of the day by aggregating the probability map for each of the set of regions of interest for the pre-defined timeslot; and
determining the optimal position of each of the plurality of smart bins within the geographical area for the pre-defined timeslot based on the positioning probability map for the geographical area for the pre-defined timeslot.

14. The system of claim 13, wherein the processor-executable instructions, on execution, further cause the processor to:
for each of the set of pre-defined timeslots of the day,
determine a movement policy for each of the plurality of smart bins in the pre-defined timeslot based on at least one of the positioning probability map for the pre-defined timeslot, a current position of each of the plurality of smart bins, and a current status of each of the plurality of smart bins; and
effect positioning of each of the plurality of smart bins within the geographical area based on the respective movement policy.

15. The system of claim 13, wherein determining the optimal position of each of the plurality of smart bins within the geographical area comprises:
generating, by the master smart bin control device, an aggregated positioning probability map for the geographical area by aggregating the positioning probability map for each of the set of pre-defined timeslots of the day; and
determining, by the master smart bin control device, the optimal position of each of the plurality of smart bins within the geographical area based on the aggregated positioning probability map for the geographical area.

16. The system of claim 15, wherein the processor-executable instructions, on execution, further cause the processor to:
determine a movement policy for each of the plurality of smart bins based on at least one of the aggregated positioning probability map for the pre-defined timeslot, a current position of each of the plurality of smart bins, and a current status of each of the plurality of smart bins; and
effect positioning of each of the plurality of smart bins within the geographical area based on the respective movement policy.

17. The system of claim 10, wherein the processor-executable instructions, on execution, further cause the processor to:
receive a real-time video feed of the region of interest;
determine a need of the smart bin at a position of interest or for a person of interest, within the region of interest, based on an evaluation of the real-time video feed; and
upon determining the need, effect a movement of the smart bin to the position of interest or to the person of interest.

18. The system of claim 17, wherein the processor-executable instructions, on execution, further cause the processor to:
evaluate an effectiveness of the movement of the smart bin based on an occurrence of actual trashing of a trash in the smart bin; and
update a decision-making logic for determining the need based on the effectiveness.

19. A non-transitory computer-readable storage medium having stored thereon, a set of computer-executable instructions causing a computer comprising one or more processors to perform steps comprising:
for each of a set of regions of interest within a geographical area and for each of a set of pre-defined timeslots of a day,
determining a set of evaluation parameters for a region of interest based on an evaluation of video feeds for the region of interest; and
generating a probability map for the region of interest based on the set of evaluation parameters, wherein the probability map corresponds to a need of one or more of the plurality of smart bins at one or more different positions within the region of interest; and
determining the optimal position of each of the plurality of smart bins within the geographical area based on the probability map for each of the set of regions of interest and for each of the set of pre-defined timeslots of the day.

20. The non-transitory computer-readable storage medium of claim 19, wherein the steps further comprise:
receiving a real-time video feed of the region of interest;
determining a need of the smart bin at a position of interest or for a person of interest, within the region of interest, based on an evaluation of the real-time video feed;
upon determining the need, effecting a movement of the smart bin to the position of interest or to the person of interest;
evaluating an effectiveness of the movement of the smart bin based on an occurrence of actual trashing of a trash in the smart bin; and
updating a decision-making logic for determining the need based on the effectiveness.
